(19) United States
(12) Patent Application Publication
(10) Pub. No.: US 2024/0171867 A1
(43) Pub. Date: May 23, 2024

(54) INFORMATION PROCESSING APPARATUS, INFORMATION PROCESSING METHOD, AND PROGRAM

(71) Applicant: SONY SEMICONDUCTOR SOLUTIONS CORPORATION, KANAGAWA (JP)

(72) Inventor: KAZUYUKI OKUIKE, KANAGAWA (JP)

(21) Appl. No.: 18/551,947

(22) PCT Filed: Mar. 14, 2022
(86) PCT No.: PCT/JP2022/011244

§ 371 Date: Sep. 22, 2023

(30) Foreign Application Priority Data
Apr. 12, 2021 (JP) 2021-067271

(51) Int. Cl. H04N 23/81; H04N 23/611

(52) U.S. Cl. CPC H04N 23/81; H04N 23/611

(57) ABSTRACT

An information processing apparatus is configured to perform processing of acquiring individual information used for setting an image processing parameter of RAW image data for an imaging device that captures the RAW image data and memorizing the individual information in association with the imaging device.

### TECHNICAL FIELD

The present technology relates to an information processing method, an information processing apparatus, and a program, and relates to a technology used in a case where RAW image data is handled.

### BACKGROUND ART

There is a case where RAW image data that is image data at a stage before being subjected to development processing, particularly image creation processing, is stored as image data captured by an imaging apparatus.

Patent Document 1 below discloses a technology for storing RAW image data and a geometric deformation parameter (distortion correction parameter) in association with each other in order to develop the RAW image data offline.

### CITATION LIST

### Patent Document

Patent Document 1: Japanese Patent Application Laid-Open No. 2016-134631

### SUMMARY OF THE INVENTION

### Problems to be Solved by the Invention

In the case of Patent Document 1, a geometric deformation parameter is added for each sheet (one frame) for development of RAW image data, particularly, for distortion correction. This causes a problem of an increase in data size.

The present disclosure proposes a technology that enables execution of appropriate processing on RAW image data while suppressing an increase in data size in a situation where the RAW image data is stored.

### Solutions to Problems

In an information processing method according to the present technology, an information processing apparatus performs first processing of acquiring individual information used for setting an image processing parameter of RAW image data for an imaging device that captures the RAW image data and memorizing the individual information in association with the imaging device.

In a case where an information processing apparatus that receives RAW image data from an external imaging device is assumed, individual information of the imaging device is managed in association with the imaging device.

### BRIEF DESCRIPTION OF DRAWINGS

FIG. 1 is an explanatory diagram of a system configuration by an imaging device and an information processing apparatus according to an embodiment of the present technology.

FIG. 2 is a block diagram of a sensor according to an embodiment.

FIG. 3 is an explanatory diagram of a structure example of a sensor according to an embodiment.

FIG. 4 is a block diagram of a configuration of an information processing apparatus according to an embodiment.

FIG. 5 is an explanatory diagram of processing at a setting stage and an operation stage according to an embodiment.

FIG. 6 is an explanatory diagram of processing according to a first embodiment.

FIG. 7 is a flowchart of optical center calculation processing of the information processing apparatus according to an embodiment.

FIG. 8 is an explanatory diagram of ISP processing in a sensor according to an embodiment.

FIG. 9 is a flowchart of data separation in an application processor according to an embodiment.

FIG. 10 is a flowchart of data separation in the application processor according to an embodiment.

FIG. 11 is an explanatory diagram of contents of data to be transmitted according to an embodiment.

FIG. 12 is a flowchart of distortion correction parameter calculation processing of the information processing apparatus according to an embodiment.

FIG. 13 is a flowchart of processing corresponding to wide-angle distortion at the time of calculating a distortion correction parameter of the information processing apparatus according to an embodiment.

FIG. 14 is an explanatory diagram of processing according to a second embodiment.

### MODE FOR CARRYING OUT THE INVENTION

Hereinafter, embodiments will be described in the following order.
<1. System Configuration>
<2. Apparatus Configuration>
<3. Processing Example of Setting Stage and Operation Stage>
4. First Embodiment
5. Second Embodiment
<6. Conclusion and Modification>

Note that in the present disclosure, “image data” refers to image data as a still image or a moving image. In addition, in the description of the drawings, there is a case where “image data” is omitted and referred to as “image” in some cases.

In addition, the RAW image data is image data obtained by imaging before being subjected to a part or all of the development processing. For example, data (for example, data in a red (R)/green (G)/blue (B) format) in the pixel array of the image sensor before image creation is performed, or data at a stage where the data is separated into a luminance signal and a color signal can be referred to as RAW image data. Furthermore, for example, image data at a stage where processing such as color reproduction/sharpness or the like is not performed can be referred to as RAW image data.

### 1. System Configuration

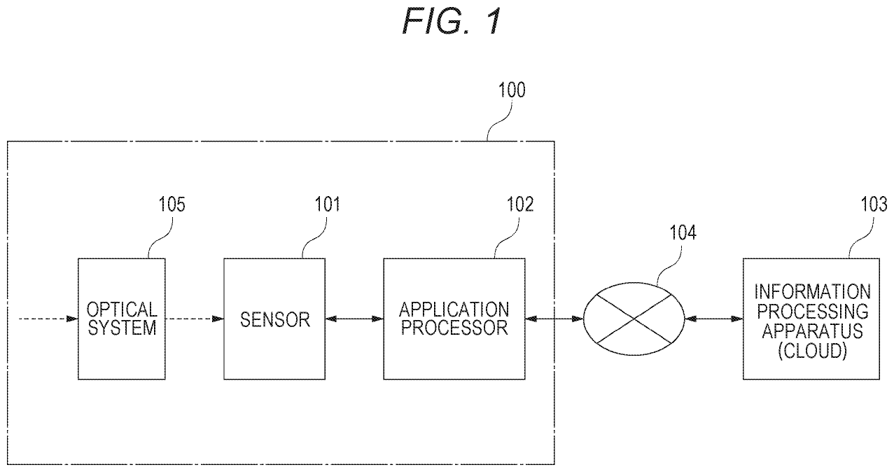

FIG. 1 illustrates a system configuration example of an embodiment. In this system, an imaging device 100 and an information processing apparatus 103 can communicate with each other via a network 104.

The imaging device 100 includes an optical system 105, a sensor 101, and an application processor 102.

The optical system 105 includes, for example, a zoom lens, a focusing lens, a diaphragm, and the like, and causes light from the outside to enter the sensor 101.

The sensor 101 is, for example, a complementary metal oxide semiconductor (CMOS) image sensor that is configured by one chip, performs imaging operations such as reception of incident light from the optical system 105 and photoelectric conversion, and outputs image data corresponding to the incident light from the optical system 105.

In addition, the sensor 101 performs, for example, recognition processing of recognizing a predetermined recognition target and other signal processing on the image data obtained by imaging, and outputs a signal processing result of the signal processing.

The application processor 102 functions as, for example, an interface (I/F) that performs data transmission with an external device, and performs data separation processing and the like related to the processing of the present disclosure.

For communication between the sensor 101 and the application processor 102, for example, a relatively high-speed parallel I/F such as a mobile industry processor interface (MIPI) or the like can be adopted.

The information processing apparatus 103 functions as a cloud server that performs image processing by cloud computing, for example.

In the present embodiment, the information processing apparatus 103 can receive RAW image data from the imaging device 100 via the network 104 and perform various processes on the RAW image data.

The information processing apparatus 103 is equipment capable of performing information processing, particularly image processing, such as computer equipment. As the information processing apparatus 103, specifically, a computer apparatus having a processing capability for implementing a server function is assumed, but for example, a personal computer, a mobile terminal device such as a smartphone, a tablet, or the like, a mobile phone, a video editing device, video reproducing equipment, or the like which have the processing function described in the present embodiment may be used.

Note that the information processing apparatus 103 is an information processing apparatus separate from the imaging device 100, but is not necessarily limited to a computer apparatus using cloud computing. For example, the information processing apparatus 103 may be used as a terminal device such as a smartphone or the like at a short distance position of the imaging device 100.

In addition, it is also assumed that the sensor 101 and the information processing apparatus 103 perform various types of analysis processing using machine learning by an artificial intelligence (AI) engine. For example, the AI engine can perform image content determination, scene determination, object recognition (including face recognition, person recognition, and the like), individual identification, posture estimation, and the like on the image data by image analysis as deep neural network (DNN) processing.

The network 104 may be a network that forms a transmission path between remote locations using Ethernet, a satellite communication line, a telephone line, or the like, or may be a network by a wireless transmission path by Wi-Fi (registered trademark) communication, Bluetooth (registered trademark), or the like. Furthermore, a network using a transmission path of wired connection using a video cable, a universal serial bus (USB) cable, a local area network (LAN) cable, or the like may be used.

In such a system, image capturing is performed by the sensor 101, and image data is output. The image data output from the sensor 101 is transmitted to the information processing apparatus 103 by the application processor 102. The information processing apparatus 103 can memorize the transmitted image data and perform various processes using the image data.

Here, it is assumed that the image data transmitted from the imaging device 100 to the information processing apparatus 103 is RAW image data. The information processing apparatus 103 memorizes the sequentially transmitted RAW image data, performs development processing, object recognition processing, analysis processing based on an image or object recognition, and the like on the RAW image data as necessary, and provides various types of information to the user.

In the present embodiment, it is assumed that RAW image data is handled by the information processing apparatus 103 in this manner, and more accurate information provision is performed and an increase in the necessary data amount is suppressed.

### 2. Apparatus Configuration

Hereinafter, configuration examples of the sensor 101 and the information processing apparatus 103 will be described.

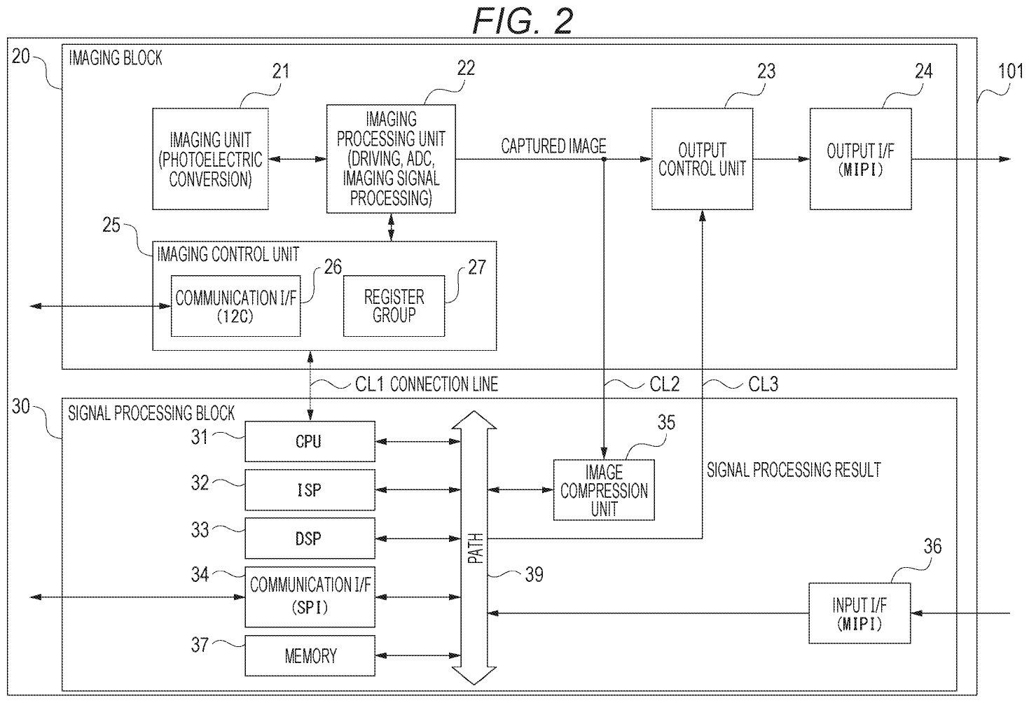

FIG. 2 illustrates a configuration example of the sensor 101.

The sensor 101 includes an imaging block 20 and a signal processing block 30.

The imaging block 20 and the signal processing block 30 are electrically connected by connection lines (internal buses) CL1, CL2, and CL3.

The imaging block 20 includes an imaging unit 21, an imaging processing unit 22, an output control unit 23, an output interface (I/F) 24, and an imaging control unit 25.

The imaging unit 21 is configured by a plurality of pixels arranged two-dimensionally. The imaging unit 21 is driven by the imaging processing unit 22 and captures an image.

That is, when light from the optical system 105 (FIG. 1) is incident on the imaging unit 21, each pixel in the imaging unit 21 receives the incident light and performs photoelectric conversion. An analog signal obtained by the photoelectric conversion is output as an image signal corresponding to incident light.

Note that the size of the image (signal) output by the imaging unit 21 can be selected from a plurality of sizes such as 12 M (3968×2976) pixels, a video graphics array (VGA) size (640×480 pixels), and the like, for example.

Furthermore, for the image output by the imaging unit 21, for example, it is possible to select whether to set a color image of RGB (Red, Green, Blue) or a monochrome image of only luminance.

These selections can be made as a type of imaging mode setting.

Under the control of the imaging control unit 25, the imaging processing unit 22 performs processing related to image capturing in the imaging unit 21, such as driving of the imaging unit 21, analog to digital (AD) conversion of an analog image signal output from the imaging unit 21, imaging signal processing, or the like.

Here, examples of the imaging signal processing include processing of obtaining brightness for each small region by calculating an average value of pixel values for each predetermined small region with respect to the image output by the imaging unit 21, processing of converting the image output from the imaging unit 21 into a high dynamic range (HDR) image, defect correction, development, and the like.

The imaging processing unit 22 outputs a digital image signal obtained by AD conversion or the like of the analog image signal output from the imaging unit 21 as a captured image.

In the case of the present embodiment, a captured image is output as at least RAW image data.

The captured image output by the imaging processing unit 22 is supplied to the output control unit 23 and also supplied to an image compression unit 35 of the signal processing block 30 via the connection line CL2.

In addition to the captured image supplied from the imaging processing unit 22, various types of information such as a signal processing result of signal processing using the captured image and the like are supplied from the signal processing block 30 to the output control unit 23 via the connection line CL3. For example, recognition information and imaging information to be described later are supplied.

The output control unit 23 performs output control of outputting the captured image from the imaging processing unit 22 and the signal processing result from the signal processing block 30 from the output I/F 24 to the outside. For example, control of outputting to the application processor 102 in FIG. 1 is performed.

For example, the output control unit 23 selects a captured image from the imaging processing unit 22 or a signal processing result (recognition information and imaging information to be described later) from the signal processing block 30, and supplies the same to the output I/F 24.

The output I/F 24 is an I/F that outputs the captured image and the signal processing result supplied from the output control unit 23 to the outside.

For example, a relatively high-speed parallel I/F or the like such as MIPI or the like can be adopted as the output I/F 24.

The output I/F 24 outputs the captured image from the imaging processing unit 22 or the signal processing result from the signal processing block 30 to the outside according to the output control of the output control unit 23.

Therefore, for example, in a case where only the signal processing result from the signal processing block 30 is necessary on the outside and the captured image itself is not necessary, only the signal processing result can be output, and the amount of data output from the output I/F 24 to the outside can be reduced.

Furthermore, in the signal processing block 30, signal processing for obtaining a signal processing result necessary on the outside is performed, and the signal processing result is output from the output I/F 24, so that it is not necessary to perform signal processing on the outside, and a load on an external block can be reduced.

The imaging control unit 25 includes a communication I/F 26 and a register group 27.

The communication I/F 26 is, for example, a first communication I/F such as a serial communication I/F such as an inter integrated circuit (I2C), and exchanges necessary information such as information and the like to be read from and written to the register group 27 with the outside.

The register group 27 includes a plurality of registers and memorize imaging information related to imaging of an image by the imaging unit 21 and other various types of information. For example, the register group 27 memorizes information received from the outside in the communication I/F 26 and a result of imaging signal processing in the imaging processing unit 22. Such information related to the imaging processing at the time of imaging is referred to as “imaging information” for the sake of description.

Examples of the imaging information memorized in the register group 27 include, for examples, information indicating ISO sensitivity (analog gain at the time of AD conversion in the imaging processing unit 22), exposure time (shutter speed), frame rate, focus, imaging mode, and the like, cutout position information, horizontal/vertical rotation information, and the like.

The imaging mode includes, for example, a manual mode in which the exposure time, the frame rate, and the like are manually set, and an automatic mode in which the exposure time, the frame rate, and the like are automatically set according to the scene. Examples of the automatic mode include modes corresponding to various image scenes such as a night scene and a person's face, or the like.

Furthermore, the cutout position information is information indicating a range to be cut out from the image output by the imaging unit 21 in a case where a part of the image output by the imaging unit 21 is cut out and output as a captured image in the imaging processing unit 22. Specifying the cutout range enables, for example, cutout or the like from the image to be output by the imaging unit 21 of only a range in which a person appears.

Furthermore, for so-called camera shake correction, the imaging processing unit 22 may adjust the cutout range for each frame according to information of an angular velocity sensor or an acceleration sensor (not illustrated) provided in the imaging device 100.

Note that image cutout includes, in addition to a method of cutting out from an image to be output from the imaging unit 21, a method of cutting out only an image (signal) in a cutout range from the imaging unit 21.

The horizontal/vertical rotation information is information of changes in the horizontal direction and the vertical direction due to vertical/horizontal switching of the image, inclination correction, and the like.

The imaging control unit 25 controls the imaging processing unit 22 according to the imaging information memorized in the register group 27, thereby controlling imaging of an image in the imaging unit 21.

Note that the register group 27 can memorize, as imaging information, output control information regarding output control in the output control unit 23 in addition to a result of imaging signal processing in the imaging processing unit 22.

The output control unit 23 can perform output control of selectively outputting the captured image and the signal processing result according to the output control information memorized in the register group 27.

Furthermore, in the sensor 101, the imaging control unit 25 and a CPU 31 of the signal processing block 30 are connected via the connection line CL1, and the CPU 31 can read and write information from and to the register group 27 via the connection line CL1.

That is, in the sensor 101, reading and writing of information from and to the register group 27 can be performed not only by the communication I/F 26 but also by the CPU 31.

The signal processing block 30 includes a central processing unit (CPU) 31, an image signal processor (ISP) 32, a digital signal processor (DSP) 33, a communication I/F 34, an image compression unit 35, an input I/F 36, and a memory 37, and performs predetermined signal processing using a captured image or the like obtained by the imaging block 20.

The above-described units from the CPU 31 to the memory 37 constituting the signal processing block 30 are connected to each other via a bus 39, and can exchange information as necessary.

The CPU 31 performs the program memorized in the memory 37 to perform various processes such as control of the signal processing block 30, reading and writing of information via the connection line CL1 from and to the register group 27 of the imaging control unit 25, and other various types of processing.

For example, by executing the program, the CPU 31 can function as a calculation unit that calculates imaging information using a signal processing result obtained by signal processing in the DSP 33, and can cause new imaging information calculated by using the signal processing result to be fed back to the register group 27 of the imaging control unit 25 via the connection line CL1 and memorized therein.

Therefore, the CPU 31 can control the imaging operation in the imaging unit 21 and the imaging signal processing in the imaging processing unit 22 according to the signal processing result of the captured image.

Furthermore, the imaging information memorized in the register group 27 by the CPU 31 can be provided (output) to the outside from the communication I/F 26. For example, the focus information in the imaging information memorized in the register group 27 can be provided from the communication I/F 26 to a focus driver (not illustrated) that controls the focus.

By executing the program memorized in the memory 37, the ISP 32 functions as a signal processing unit that performs signal processing using a captured image supplied from the imaging processing unit 22 to the signal processing block 30 via the connection line CL2 and information received by the input I/F 36 from the outside.

As a result, the ISP 32 generates an input image of recognition processing in the DSP 33.

By executing the program memorized in the memory 37, the DSP 33 functions as a signal processing unit that performs signal processing using a captured image supplied from the imaging processing unit 22 to the signal processing block 30 via the connection line CL2 and information received by the input I/F 36 from the outside.

In particular, in the present embodiment, object recognition processing such as DNN processing or the like can be performed on the input image from the ISP 32.

The memory 37 includes a static random access memory (SRAM), a dynamic RAM (DRAM), or the like, and memorizes data or the like necessary for processing by the signal processing block 30.

For example, the memory 37 memorizes a program received from the outside in the communication I/F 34, a captured image compressed by the image compression unit 35 and used in signal processing in the ISP 32 or the DSP 33, recognition information that is a result of recognition processing performed in the DSP 33, information (imaging information) of processing at the time of imaging performed under the control of the CPU 31 or the imaging control unit 25, information received by the input I/F 36, information output from the output I/F 24 among the information memorized in the register group 27, and the like. As described above, the imaging information includes cutout position information, horizontal/vertical rotation information, and the like.

Imaging information including recognition information, cutout position information, horizontal/vertical rotation information, and the like can be sequentially transferred from the memory 37 to the output control unit 23 and output from the output I/F 24.

The communication I/F 34 is, for example, a second communication I/F such as a serial communication I/F of a serial peripheral interface (SPI) and the like, and exchanges, with the outside, necessary information such as a program or the like executed by the CPU 31 and DSP 33.

For example, the communication I/F 34 downloads a program executed by the CPU 31 or the DSP 33 from the outside, supplies the program to the memory 37 and causes the program to be memorized therein.

Therefore, various processes can be executed by the CPU 31 or the DSP 33 by the program downloaded by the communication I/F 34.

Note that the communication I/F 34 can exchange not only programs but also any desired data with the outside.

For example, the communication I/F 34 can output the signal processing result obtained by the signal processing in the DSP 33 to the outside.

Furthermore, the communication I/F 34 outputs information according to an instruction of the CPU 31 to an external device, so that the external device can be controlled according to the instruction of the CPU 31.

A captured image is supplied from the imaging processing unit 22 to the image compression unit 35 via the connection line CL2. The image compression unit 35 performs compression processing for compressing the captured image, and generates a compressed image having a small amount of data as compared with the captured image. The compressed image generated by the image compression unit 35 is supplied to the memory 37 via the bus 39 and memorized therein.

Note that the image compression unit 35 directly memorizes the captured image in the memory 37 in some cases without performing compression.

The compressed (or uncompressed) captured image memorized in the memory 37 is subjected to processing by the ISP 32 or the DSP 33.

That is, the signal processing in the ISP 32 or the DSP 33 can be performed using not only the captured image itself but also the compressed image generated from the captured image by the image compression unit 35. Since the compressed image has a smaller amount of data than the captured image, it is possible to reduce the load of the signal processing in the ISP 32 or the DSP 33 and to memorize the storage capacity of the memory 37 that stores the compressed image.

As the compression processing in the image compression unit 35, for example, scale-down for converting a captured image of 12 M (3968×2976) pixels into an image of a VGA size can be performed. Furthermore, in a case where the signal processing in the ISP 32 or the DSP 33 is performed on luminance and the captured image is an RGB image, YUV conversion for converting the RGB image into, for example, a YUV image can be performed as the compression processing.

Note that the image compression unit 35 can be implemented by software or can be implemented by dedicated hardware.

The input I/F 36 is an I/F that receives information from the outside. The input I/F 36 receives, for example, an output of an external sensor (external sensor output) from the external sensor, and causes the output to be supplied to the memory 37 via the bus and memorized therein.

Similarly to the output I/F 24, for example, a parallel I/F or the like such as an MIPI or the like can be adopted as the input I/F 36.

Furthermore, as the external sensor, for example, a distance sensor that senses information regarding a distance can be adopted.

Furthermore, as the external sensor, for example, an image sensor that senses light and outputs an image corresponding to the light, that is, an image sensor different from the sensor 101 can be adopted.

Furthermore, as the external sensor, an angular velocity sensor, an acceleration sensor, or the like that detects the behavior of the imaging device 100 can also be adopted.

In the CPU31, the ISP 32, and the DSP 33, besides using (the compressed image generated from) the captured image, the signal processing can be performed using the external sensor output received by the input I/F 36 from the external sensor as described above and memorized in the memory 37.

In the one-chip sensor 101 configured as described above, signal processing using (a compressed image generated from) a captured image obtained by imaging by the imaging unit 21 is performed by the ISP 32, the DSP 33, and a signal processing result of the signal processing and the captured image are selectively output from the output I/F 24. In particular, in the present embodiment, a captured image as RAW image data, the above-described recognition information, imaging information, and the like are output from the output I/F 24.

Therefore, it is possible to configure the sensor 101 that outputs information needed by the user in a downsizing manner.

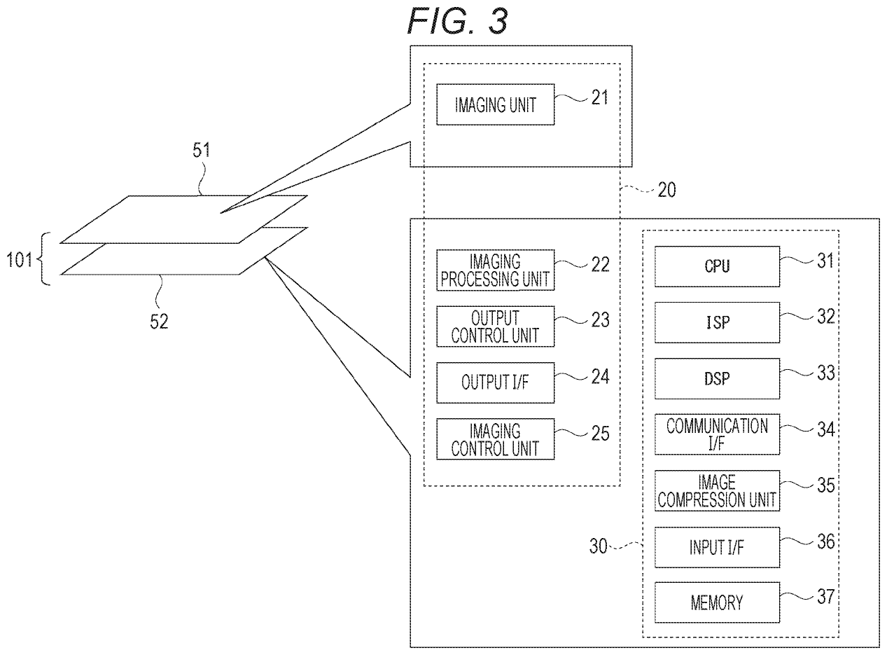

FIG. 3 schematically illustrates an external configuration example of the sensor 101.

The sensor 101 can be configured as, for example, a one-chip semiconductor device having a stacked structure in which a plurality of dies is stacked.

FIG. 3 illustrates an example in which the sensor 101 is configured by stacking two dies of dies 51 and 52.

As illustrated, the imaging unit 21 is mounted on the die 51 on the upper side, and each unit from the imaging processing unit 22 to the imaging control unit 25 and each unit from the CPU 31 to the memory 37 are mounted on the die 52 on the lower side.

The die 51 on the upper side and the die 52 on the lower side are electrically connected by, for example, forming a through hole that penetrates the die 51 and reaches the die 52, performing Cu—Cu bonding for directly connecting Cu wiring exposed on a lower surface side of the die 51 and Cu wiring exposed on an upper surface side of the die 52, or the like. Here, in the imaging processing unit 22, as a method of performing AD conversion of the image signal output from the imaging unit 21, for example, a column-parallel AD method or an area AD method can be employed.

In the column-parallel AD method, for example, an AD converter (ADC) is provided for a column of pixels that configure the imaging unit 21, and the ADC in each column is in charge of pixel signal AD conversion of the pixels in the column, by which AD conversion of the image signals of the pixels in the respective columns is performed in parallel for one row. In a case where the column-parallel AD method is adopted, a part of the imaging processing unit 22 that performs AD conversion using the column-parallel AD method may be mounted on the die 51 on the upper side.

In the area AD method, pixels that configure the imaging unit 21 are separated into a plurality of blocks, and an ADC is provided for each block. Then, the ADC of each block is in charge of AD conversion of the pixel signals of the pixels of the block, so that AD conversion of image signals of the pixels of the plurality of blocks is performed in parallel. In the area AD method, AD conversion (reading and AD conversion) of an image signal can be performed only for necessary pixels among pixels that configures the imaging unit 21 with a block as a smallest unit.

Note that, if the area of the sensor 101 is allowed to be large, the sensor 101 can be configured with one die.

Furthermore, in FIG. 3, the sensor 101 of one chip is configured by stacking the two dies 51 and 52, but the sensor 101 of one chip can be configured by stacking three or more dies. For example, in a case where the sensor 101 of one chip is configured by stacking three dies, the memory 37 of FIG. 3 can be mounted on another die.

By the way, in a case where the sensor 101 is configured by connecting chips such as a sensor chip, a memory chip, a DSP chip, and the like in parallel with a plurality of bumps, the thickness greatly increases as compared with the sensor 101 of one chip configured in a stacked structure, and the device becomes large.

Furthermore, in that case, it can be difficult to secure a sufficient rate as a rate at which the captured image is output from the imaging processing unit 22 to the output control unit 23 due to signal deterioration or the like at the connection portion of the bump.

According to the sensor 101 having the stacked structure as illustrated in FIG. 3, it is possible to prevent the above-described increase in size of the device and inability to secure a sufficient rate as a rate between the imaging processing unit 22 and the output control unit 23.

Therefore, with the sensor 101 having the stacked structure, it is possible to configure the imaging apparatus that outputs information required by the user in a downsizing manner.

In a case where the information required by the user is a captured image, the sensor 101 can output the captured image.

Furthermore, in a case where the information needed by the user is obtained by signal processing using a captured image, the sensor 101 can obtain and output a signal processing result as the information needed by the user by performing this signal processing, for example, recognition processing of recognizing a predetermined recognition target from the captured image in the DSP 33 or the like.

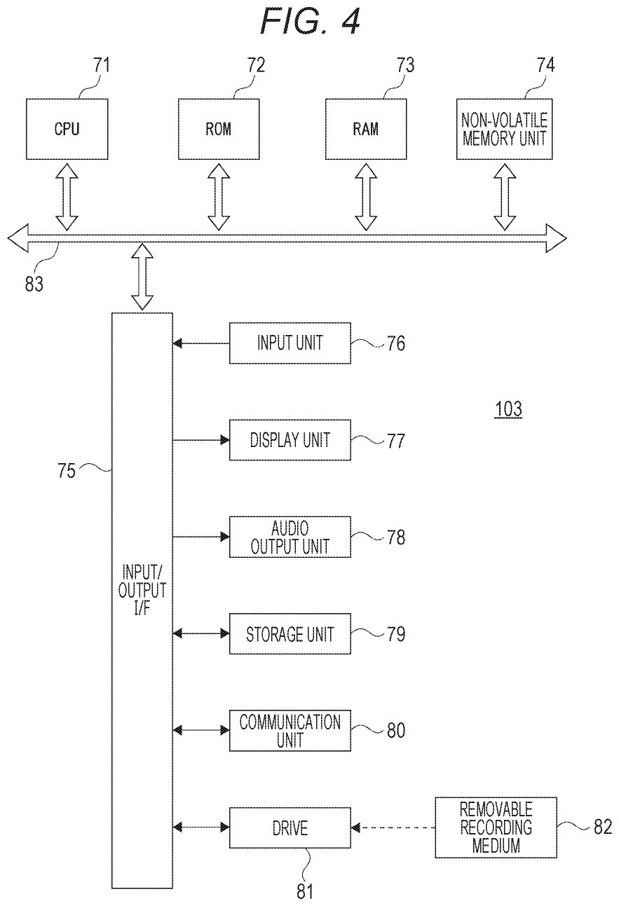

Next, a configuration example of the information processing apparatus 103 that functions as, for example, a cloud server or the like as illustrated in FIG. 1 will be described with reference to FIG. 4.

A CPU 71 of the information processing apparatus 103 executes various types of processing in accordance with a program memorized in a non-volatile memory unit 74 such as a ROM 72 or, for example, an electrically erasable programmable read-only memory (EEP-ROM), or a program loaded from a storage unit 79 to a RAM 73. The RAM 73 also appropriately memorizes data and the like necessary for the CPU 71 to execute the various types of processing.

The CPU 71, the ROM 72, the RAM 73, and the non-volatile memory unit 74 are connected to one another via a bus 83. An input/output interface 75 is also connected to the bus 83.

Note that, in a case where the information processing apparatus 103 performs image processing or DNN processing, a graphics processing unit (GPU), a general-purpose computing on graphics processing unit (GPGPU), an AI-dedicated processor, or the like may be provided instead of the CPU 71 or together with the CPU 71.

An input unit 76 configured with an operation element and an operation device is connected to the input/output interface 75. For example, as the input unit 76, various types of operation elements and operation devices such as a keyboard, a mouse, a key, a dial, a touch panel, a touch pad, a remote controller, and the like are assumed.

A user operation is detected by the input unit 76, and a signal corresponding to an input operation is interpreted by the CPU 71.

A microphone is also assumed as the input unit 76. A voice uttered by the user can also be input as the operation information.

In addition, a display unit 77 including an LCD, an organic EL panel, or the like, and an audio output unit 78 including a speaker or the like are connected to the input/output interface 75 integrally or separately.

The display unit 77 is a display unit that performs various types of displays, and includes, for example, a display device provided in a housing of the information processing apparatus 103, a separate display device connected to the information processing apparatus 103, or the like.

The display unit 77 executes display of an image for various types of image processing, a moving image to be processed, and the like on a display screen on the basis of an instruction from the CPU 71. Furthermore, the display unit 77 can display various types of operation menus, icons, messages, and the like, that is, displays as a graphical user interface (GUI) on the basis of the instruction from the CPU 71.

In some cases, the storage unit 79 including a hard disk, a solid-state memory, or the like, and a communication unit 80 including a modem or the like are connected to the input/output interface 75.

The storage unit 79 is used to house various types of information. In the case of the present embodiment, for example, an image storage DB 42, an information storage DB 44, a DB 47, or the like to be described later can be configured in the storage unit 79.

The communication unit 80 performs communication with communication processing via a transmission line such as a network 104 or the like, wired/wireless communication with various types of equipment, bus communication, or the like.

A drive 81 is also connected to the input/output interface 75 as necessary, and a removable recording medium 82 such as a magnetic disk, an optical disk, a magneto-optical disk, a semiconductor memory, or the like is appropriately mounted.

The drive 81 can read a data file such as an image file, various types of computer programs, and the like from the removable recording medium 82. The read data file is memorized in the storage unit 79, and images and sound included in the data file are output by the display unit 77 and the audio output unit 78. In addition, the computer program and the like read from the removable recording medium 82 are installed in the storage unit 79, as necessary.

In the information processing apparatus 103, for example, software for processing of the present embodiment can be installed via network communication by the communication unit 80 or the removable recording medium 82. Alternatively, the software may be memorized in advance in the ROM 72, the storage unit 79, or the like.

### 3. Outline of Embodiment and Processing Examples of Setting Stage and Operation Stage

An outline of processing of the embodiment will be described.

In the embodiment, it is assumed that RAW image data captured by the sensor 101 is uploaded to the information processing apparatus 103 on the cloud side, and the image and information based on the image are used for various services.

An example of the service will be described.

For example, it is conceivable to configure a monitoring system or an observation system by using the imaging device 100 as a monitoring camera or a fixed point camera.

The image data captured by the sensor 101 is sequentially uploaded to the information processing apparatus 103 as a cloud server. The information processing apparatus 103 can provide the uploaded image to the user, and can provide information of a detection result and an analysis result from the image, for example, recognition information of a specific person, number-of-people information in a unit time, congestion information, weather information, and the like to the user.

Furthermore, a case is also assumed in which the imaging device 100 is used as a monitor camera of a product of a store, and the information processing apparatus 103 generates and provides to the user a product sales status, missing item information, and the like on the basis of an image.

Furthermore, a case is also assumed in which the imaging device 100 is used as a monitor camera of a manufacturing line of a factory, and the information processing apparatus 103 generates and provides to the user a state of a product, defective product information, line operation status information, and the like on the basis of an image.

Although these various use cases are assumed, in the present embodiment, an image uploaded from the imaging device 100 on the edge side to the information processing apparatus 103 on the cloud side is assumed to be RAW image data.

The information processing apparatus 103 performs development processing on the RAW image data as necessary, subject analysis processing, target information analysis processing from the image, or the like. As a result, information necessary for the service is generated and provided to the user.

In such a case, it is considered that image distortion correction and image processing are appropriately performed in the information processing apparatus 103.

For example, in order to perform distortion correction on RAW image data, it is necessary to associate the RAW image data with a geometric deformation parameter, that is, a distortion correction parameter. However, managing the distortion correction parameter in association with each frame of the RAW image data on the information processing apparatus 103 side leads to an increase in the amount of necessary data.

Therefore, the information processing apparatus 103 separately manages the RAW image data and the distortion correction parameter.

Specifically, optical center information of a lens in the imaging device 100 that has captured RAW image data is managed in association with the device. Therefore, it is not necessary to memorize and manage the geometric deformation parameter and the like for each frame of the RAW image data, and enlargement of the data size is suppressed.

In a case where the optical axis center in the imaging device 100 is deviated from the image center of the RAW image data at the time of creating the geometric deformation parameter for distortion correction, there is a circumstance that distortion correction cannot be appropriately performed. For example, in a case where an inexpensive lens is used in the imaging device 100, the lens is screwed for focusing, but this operation rotates the positions of the optical axis center and the image center. For example, in order to cope with such a situation, the information processing apparatus 103 is configured such that the geometric deformation parameter can be created for each individual of the imaging device 100.

As information managed in association with each frame of the RAW image data, imaging information and recognition information are used.

The imaging information includes cutout position information, horizontal/vertical rotation information, and the like.

The recognition information is information of a recognition result of the subject such as, for example, DNN result information or the like performed in the DSP 33.

By using these, the accuracy of the distortion correction parameter generated on the information processing apparatus 103 side is improved.

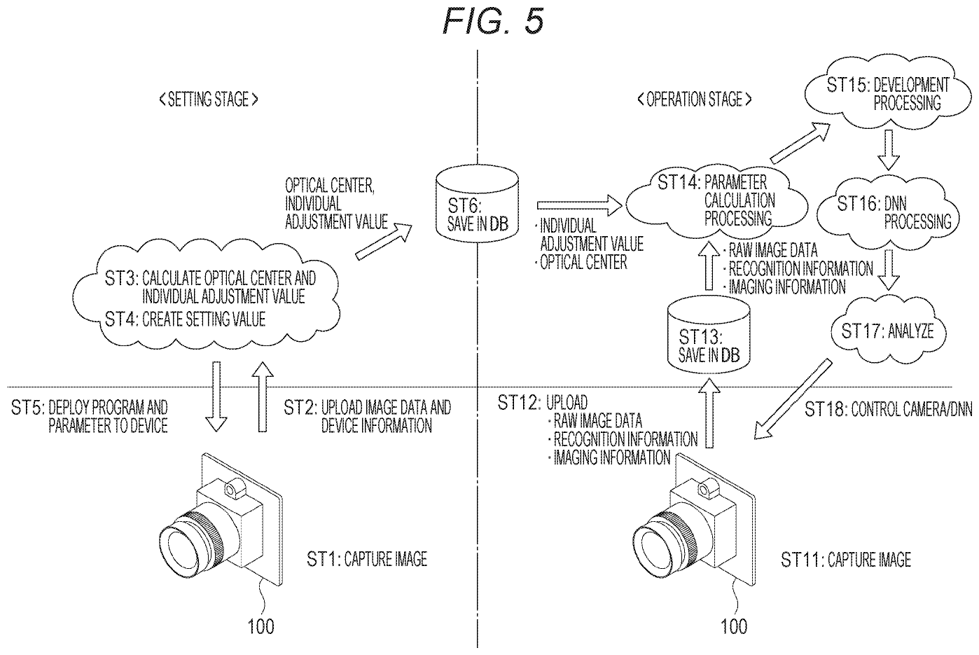

FIG. 5 illustrates a procedure of the setting stage and a procedure of the operation stage.

The operation procedure on the imaging device 100 side is illustrated as the edge side in the lower part of the figure, and the operation procedure on the information processing apparatus 103 side is illustrated as the cloud side in the upper part of the figure.

First, processing and operation in the setting stage will be described as procedures ST1 to ST6.

### Procedure ST1

In the imaging device 100, for example, a predetermined image for setting is captured at the time of installation at a site where imaging is performed. For example, an image called a grid image, Macbeth, or the like is prepared and captured.

### Procedure ST2

The imaging device 100 uploads the captured image obtained by the imaging in the procedure ST1 and other necessary device information of the imaging device 100 to the information processing apparatus 103. The device information here includes identification information of the imaging device 100, lens data indicating the type, characteristics, and the like of the lens, and information such as characteristics unique to the imaging device 100, such as RGB sensitivity of the image sensor (imaging unit 21) and the like.

### Procedure ST3

The information processing apparatus 103 calculates an adjustment value (hereinafter referred to as an “individual adjustment value”) according to the optical center in the imaging device 100 and the characteristics of the imaging device 100.

The individual adjustment value is an adjustment value suitable for use in image processing on image data captured by the imaging device 100, such as a parameter for hue adjustment according to the characteristics of the imaging device 100, a parameter for shading correction, or the like, for example.

Note that, in the present disclosure, information that is a source of calculation of a correction parameter used for image processing of RAW image data according to an individual of the imaging device 100, such as an optical center, an individual adjustment value, and the like is collectively referred to as individual information. All or a part of the above-mentioned device information is the individual information in some cases, and the device information is not the individual information in other cases.

### Procedure ST4

The information processing apparatus 103 creates a setting value to be fed back to the imaging device 100.

### Procedure ST5

Parameters and programs are deployed in the imaging device 100 on the basis of the setting values created by the information processing apparatus 103.

### Procedure ST6

The information processing apparatus 103 stores the optical center and the individual adjustment value calculated in the procedure ST3 in a database (DB) together with the device information for specifying the device.

Through the above procedures, the information processing apparatus 103 enters a state in which the individual information corresponding to the imaging device 100, that is, the optical center information and the individual adjustment value can be managed. Note that, for this purpose, it is sufficient that at least procedures ST1, ST2, ST3, and ST6 are performed.

Subsequently, procedures ST11 to ST16 will be described as processing or operation at the operation stage.

### Procedure ST11

The imaging device 100 performs imaging in an actual installation environment.

### Procedure ST12

The imaging device 100 uploads the captured image obtained by the imaging in the procedure ST11 and information accompanying the imaging to the information processing apparatus 103. In this case, RAW image data as a captured image is uploaded to the information processing apparatus 103, and recognition information and imaging information corresponding to a frame of the RAW image data are uploaded as information accompanying imaging.

The recognition information is recognition information as a result of performing image signal processing and object recognition processing in the sensor 101 on the captured RAW image data. The imaging information is cutout position information in a case where cutout is performed at the time of imaging of the RAW image data, and horizontal/vertical rotation information by horizontal-vertical conversion or rotation adjustment.

### Procedure ST13

The frame of the RAW image data to be uploaded, the recognition information, and the imaging information are associated with each other and stored in the DB on the information processing apparatus 103 side.

### Procedure ST14

The information processing apparatus 103 calculates a parameter for development processing on the RAW image data imported into the DB. In this case, the information of the optical center and the individual adjustment value stored in association with the imaging device 100 at the setting stage is used.

In addition, recognition information and imaging information stored in association with the frame of the RAW image data are also used. Specifically, distortion correction is performed in the development processing, but the optical center, the recognition information, and the imaging information can be used in calculating the distortion correction parameter for distortion correction.

### Procedure ST15

The information processing apparatus 103 performs development processes using the calculated parameter on the RAW image data imported into the DB.

For example, in the development processing, various processes including distortion correction, color processing, shading correction, and the like are performed. For distortion correction, the distortion correction parameter calculated in a procedure ST14 is used. In addition, an individual adjustment value can be used for color processing, shading correction, and the like.

### Procedure ST16

The information processing apparatus 103 can perform DNN processing or the like on the developed image data. This is to perform person recognition, class determination, object recognition, and the like for recognizing a subject required for the service being operated.

### Procedure ST17

The information processing apparatus 103 analyzes the result of the recognition processing, and generates, for example, information to be provided to the user of the operating service. Furthermore, information to be fed back to the imaging device can be generated.

### Procedure ST18

In a case where the information processing apparatus 103 generates information to be fed back to the imaging device 100, the information can be transmitted to the imaging device 100 and used for imaging control and DNN processing in the imaging device 100. For example, it is assumed that imaging operation control is performed or a parameter of recognition processing is changed.

According to the above procedures, in the operation stage, the information processing apparatus 103 can appropriately perform the development processing on the RAW image data uploaded from the imaging device 100 by using the optical center information and the individual adjustment value, and by using the recognition information and the imaging information uploaded at the same time.

In particular, by performing the procedures ST13 and ST14, the information processing apparatus 103 can appropriately perform development processing on the RAW image data in a procedure ST15.

### 4. First Embodiment

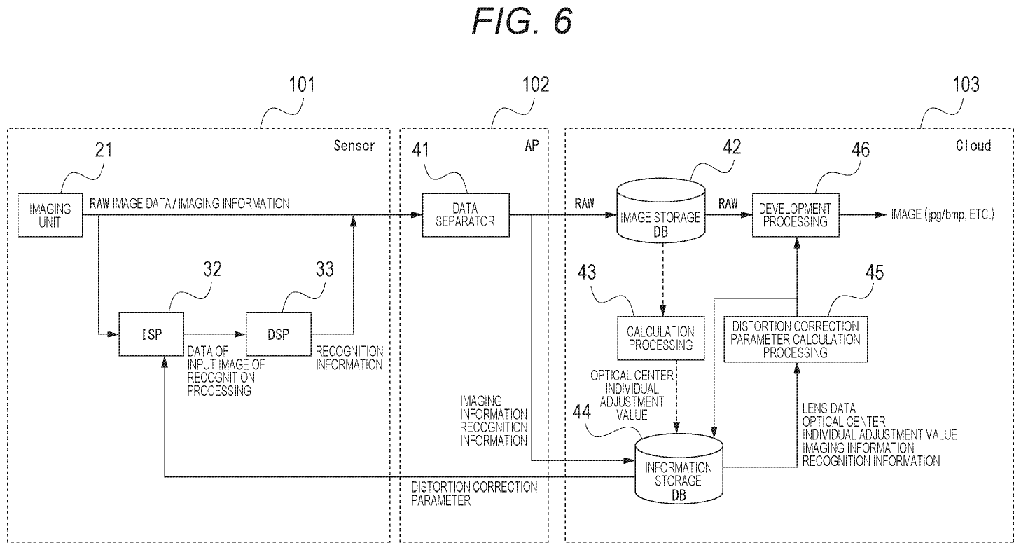

A flow of processing in a setting stage and an operation stage in FIG. 5 as a first embodiment will be described with reference to a block diagram in FIG. 6. FIG. 6 is a block diagram of functions (portions exhibiting functions) or processing of the sensor 101, the application processor 102, and the information processing apparatus 103.

As the configuration of the sensor 101, the imaging unit 21, the ISP 32, and the DSP 33 are extracted and illustrated.

In this case, the imaging unit 21 is indicated in the sense of a functional unit that outputs RAW image data and imaging information.

The ISP 32 represents a meaning as a functional unit that performs development processing on a captured image obtained by the imaging unit 21 and generates an input image for recognition processing.

The DSP 33 represents the input image data from the ISP 32 as a functional unit that performs object recognition processing by DNN.

It is indicated that data separation processing 41 is performed for the application processor 102. The data separation processing 41 is processing of separating information from the sensor 101, particularly separating RAW image data from recognition information and imaging information.

For the information processing apparatus 103, an image storage DB 42, calculation processing 43, an information storage DB 44, distortion correction parameter calculation processing 45, and development processing 46 are illustrated.

The image storage DB 42 is a DB that stores RAW image data.

The calculation processing 43 is processing of calculating an optical center and an individual adjustment value.

The information storage DB 44 is a DB that stores imaging information and recognition information.

The distortion correction parameter calculation processing 45 is processing of calculating a distortion correction parameter.

The development processing 46 is processing of developing RAW image data.

With reference to FIG. 6, the processing in the setting stage of FIG. 5, in particular, the flow of procedures ST1, ST2, ST3, and ST6 will be described.

As the image capturing in the procedure ST1, a predetermined image such as a grid image is captured by the imaging unit 21, and for example, RAW image data with the grid image as a subject is output from the sensor 101.

This RAW image data is uploaded to the information processing apparatus 103 via the application processor 102 as a procedure ST2.

Note that, in the procedures ST1 and ST2, device information regarding the imaging device 100 is also transmitted to the information processing apparatus 103.

The information processing apparatus imports the transmitted RAW image data into the image storage DB 42, and then performs calculation processing 43 as the procedure ST3 using the RAW image data.

That is, in the calculation processing 43, the optical center and the individual adjustment value are calculated. In some cases, only one of these is calculated.

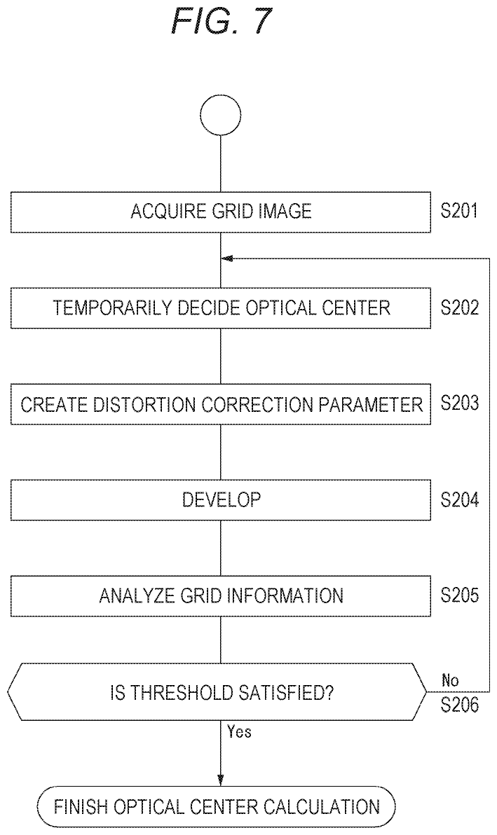

FIG. 7 illustrates an example of processing of calculating the optical center.

In step S201, the CPU 71 (see FIG. 4) of the information processing apparatus 103 acquires RAW image data, that is, a grid image, as a processing target.

In step S202, the CPU 71 temporarily sets the optical center.

In step S203, the CPU 71 creates a distortion correction parameter using the temporarily set optical center.

In step S204, the CPU 71 performs development processing including distortion correction using the created distortion correction parameter.

In step S205, the CPU 71 analyzes the grid information of the developed image. For example, whether the grid is straight, whether the grids intersect vertically, or the like is analyzed. This is to check the degree of distortion correction performed in a case where the optical center temporarily set in step S202 is used.

In step S206, the CPU 71 compares the value obtained by quantifying the linearity and the degree of vertical intersection as the analysis result with the threshold set correspondingly, and confirms whether or not the threshold condition is satisfied. This means that the optical center temporarily set in step S202 is used to confirm whether or not distortion correction has been correctly performed.

When the threshold is not satisfied, the CPU 71 returns to step S202 to temporarily set the optical center. That is, setting of an optical center that is different from before is performed. Then, the processing of step S203 and subsequent steps is performed.

That is, while changing the temporary setting of the optical center, the CPU 71 repeats the processing from step S202 to step S205 until the threshold condition is satisfied.

When the threshold condition is satisfied, the optical center temporarily set at that time is an appropriate optical center for the RAW image data to be processed. That is, it is the optical center of the imaging device 100 that has captured the RAW image data.

In a case where the individual adjustment value is calculated as the calculation processing 43, the individual adjustment value is calculated using, for example, RGB sensitivity information in the device information. For example, a hue adjustment parameter, a shading correction parameter, and the like can be calculated as individual adjustment values.

As processing corresponding to the procedure ST6, the calculated optical center and individual adjustment value are memorized in the information storage DB 44 together with the device information of the imaging device 100.

For example, the calculated optical center and individual adjustment value may be stored in association with the identification information of the imaging device 100.

Note that, in some cases, as processing corresponding to the procedures ST4 and ST5, a setting value regarding the imaging device 100 is calculated on the basis of the RAW image data at the stage of the calculation processing 43 and is fed back as, for example, a parameter of processing of the ISP 32 of the sensor 101.

Next, a flow of processing at the operation stage will be described.

Imaging as image capturing in the procedure ST11 of FIG. 5 is performed by the imaging unit 21 of FIG. 6.

Furthermore, as a procedure ST12, RAW image data, recognition information, and imaging information are uploaded to the information processing apparatus 103 via the application processor 102. The operation in this case is performed as follows.

Note that processing corresponding to the following procedures ST11 and ST12 is performed for each frame of an image to be captured.

RAW image data and imaging information are obtained by imaging by the imaging unit 21 in FIG. 6. The imaging information is actually cutout position information or horizontal/vertical conversion information memorized in the register group 27 under the control of the imaging control unit 25 in FIG. 2.

RAW image data obtained by imaging is processed by the ISP 32.

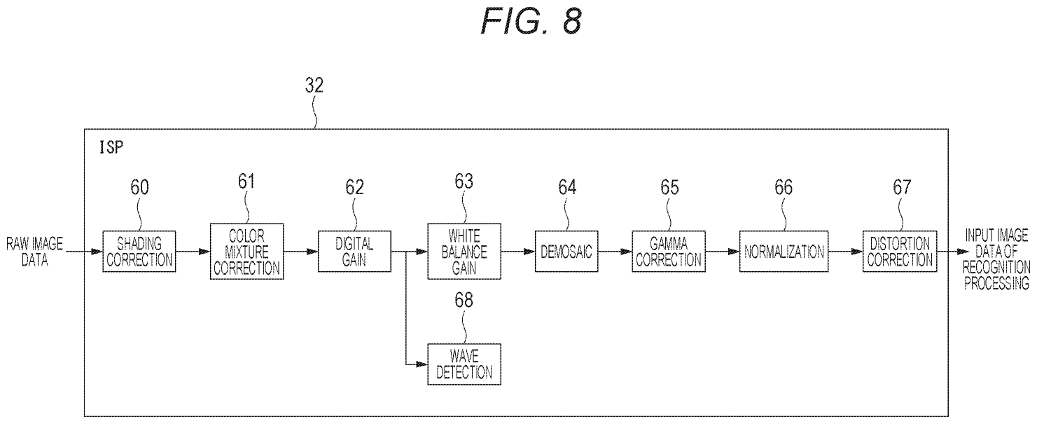

For example, as illustrated in FIG. 8, the ISP 32 performs shading correction 60, color mixture correction 61, digital gain 62, white balance gain 63, demosaic 64, gamma correction 65, normalization 66, and distortion correction 67 to generate input image data for recognition processing.

Furthermore, wave detection 68 is performed on the image data subjected to the processing of the digital gain 62, and the wave detection result is used for, for example, focus control, iris control, and the like by the imaging control unit 25.

The input image data for the recognition processing obtained by the ISP 32 is transmitted to the DSP 33 as illustrated in FIG. 6 and is set as a DNN processing target. Then, DNN processing is performed by the DSP 33 to generate recognition information.

As described above, RAW image data and imaging information are output from the imaging unit 21, recognition information is output from the DSP 33, and these are transmitted to the application processor 102 by, for example, MIPI.

The application processor 102 performs data separation processing 41 on the RAW image data, the imaging information, and the recognition information, and then transmits the RAW image data, the imaging information, and the recognition information to the information processing apparatus 103.

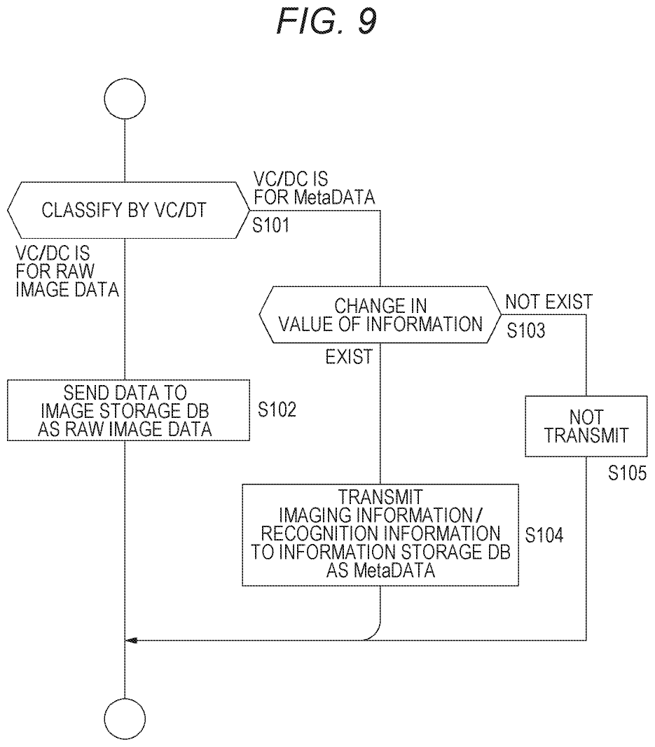

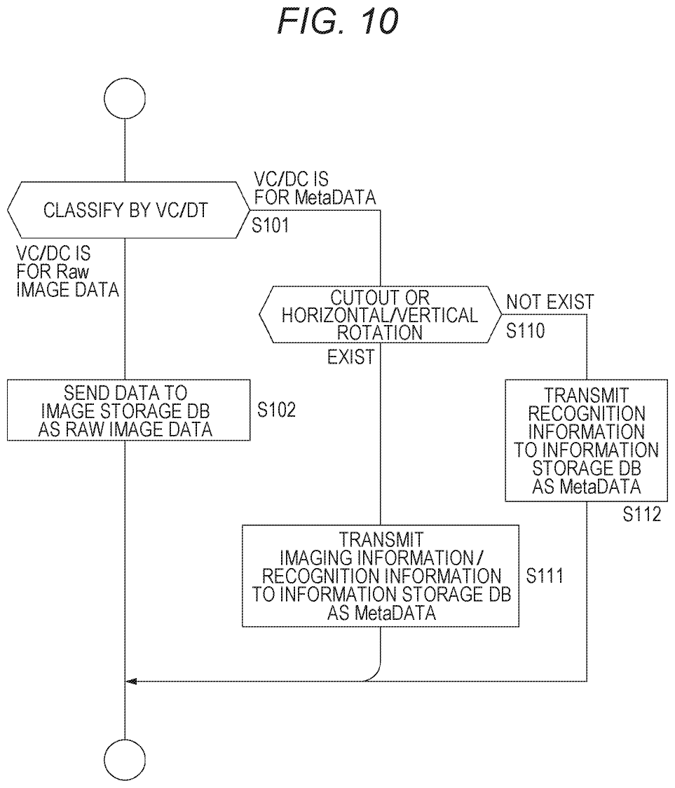

A processing example of the data separation processing 41 is illustrated in FIGS. 9 and 10.

In the processing example of FIG. 9, the application processor 102 separates, in step S101, the data by looking at the VC/DT of the header of the data received by the MIPI. VC/DT indicates a data type by values of virtual channel Id (VC) and data type (DT).

When VC/DT is a value for RAW image data, the application processor 102 transmits data to the information processing apparatus 103 as data to be stored in the image storage DB 42 in step S102. That is, in this case, the RAW image data transmitted from the sensor 101 is to be transmitted to the information processing apparatus 103.

In response to this transmission, the information processing apparatus 103 stores the RAW image data in the image storage DB 42.

If VC/DT determined in step S101 is a value for metadata, the information transmitted from the sensor 101 is imaging information or recognition information.

In this case, the application processor 102 checks whether or not there is a change in the information in step S103. For example, when the content of the current imaging information or recognition information is not changed in comparison with the imaging information or the recognition information in the frame of the last RAW image data transmitted before the previous time, the processing proceeds to step S105, and the processing in FIG. 9 is terminated without particularly performing transmission.

On the other hand, in a case where the content of the current imaging information or recognition information is changed in comparison with the imaging information or the recognition information in the frame of the last RAW image data transmitted before the previous time, the application processor 102 proceeds to step S104, and transmits the current imaging information or recognition information to the information processing apparatus 103 as data to be stored in the information storage DB 44.

In response to this transmission, the information processing apparatus 103 stores the imaging information or the recognition information in the information storage DB 44.

According to the processing example of FIG. 9, the application processor 102 transmits the imaging information and the recognition information to the frames having changed as the imaging information and the recognition information. Therefore, the amount of communication data and the amount of data managed by the information processing apparatus 103 can be reduced.

FIG. 10 illustrates another processing example as the data separation processing 41.

In step S101, the application processor 102 separates the data by looking at the VC/DT of the header of the data received by the MIPI.

When VC/DT is a value for RAW image data, the application processor 102 transmits the RAW image data to the information processing apparatus 103 as data to be stored in the image storage DB 42 in step S102.

If VC/DT determined in step S101 is a value for metadata, the information transmitted from the sensor 101 is imaging information or recognition information.

In this case, the application processor 102 determines, in step S110, whether or not the information is the cutout position information or the horizontal/vertical conversion information.

In the case of the cutout position information or the horizontal/vertical conversion information, the application processor 102 transmits, in step S111, the imaging information and the recognition information to the information processing apparatus 103 as data to be stored in the information storage DB 44.

In response to this transmission, the information processing apparatus 103 stores the imaging information and the recognition information in the information storage DB 44.

In a case where the information is not the cutout position information or the horizontal/vertical conversion information, the application processor 102 transmits, in step S112, the recognition information of the current frame to the information processing apparatus 103 as data to be stored in the information storage DB 44.

In response to this transmission, the information processing apparatus 103 stores the recognition information in the information storage DB 44.

According to the processing example of FIG. 10, the application processor 102 transmits the imaging information and the recognition information for the frame to the information processing apparatus 103 only in a case where particularly the cutout position information or the horizontal/vertical conversion information is transmitted as the imaging information from the sensor 101. In the other frames, only the recognition information is transmitted to the information processing apparatus 103. Therefore, the recognition information is managed by the information processing apparatus 103 for each frame, and the imaging information is managed by the information processing apparatus 103 only in a case where the cutout processing or the horizontal/vertical conversion processing has been performed, and the amount of data managed by the information processing apparatus 103 can be reduced.

As the procedures ST11 and ST12 in the operation stage, processing is performed as described above for each frame to be imaged.

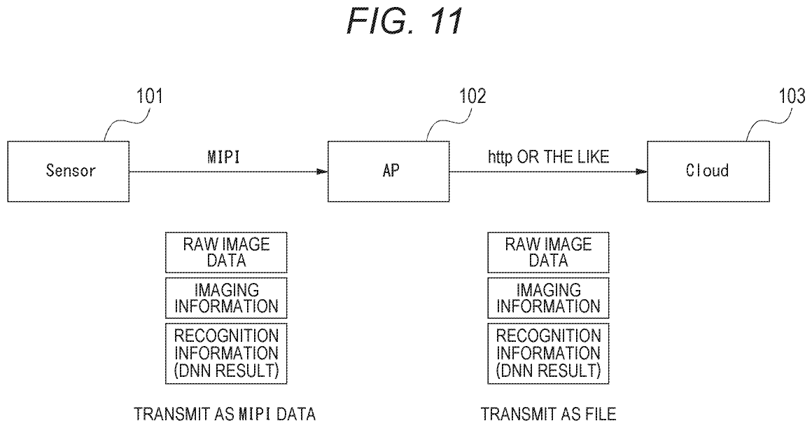

FIG. 11 illustrates information to be transmitted in the procedures ST11 and ST12.

RAW image data, imaging information, and recognition information are transmitted as MIPI data from the sensor 101 to the application processor 102.

RAW image data, imaging information, and recognition information are transmitted as file data from the application processor 102 to the information processing apparatus 103. These may be transmitted as one file, or may be divided and transmitted as respective files. The processing of FIGS. 8 and 9 is processing of an example of dividing and transmitting.

As described above, in response to the transmission from the imaging device 100, the information processing apparatus 103 memorizes RAW image data in the image storage DB 42 of FIG. 6 and memorizes imaging information and recognition information in the information storage DB 44 as the procedure ST13.

Thereafter, the information processing apparatus 103 can perform distortion correction parameter calculation processing 45 in FIG. 6 as the procedure ST14 at an any desired time point. This processing calculates the distortion correction parameter for the RAW image data using the optical center information stored in the information storage DB 44.

Furthermore, the information processing apparatus 103 can perform the development processing 46 as the procedure ST15 at any desired time point. This is development processing of RAW image data stored in the image storage DB 42. Note that it is conceivable that substantially similar processing to the processing content described in FIG. 8 is performed as the development processing. For example, processing from the shading correction 60 to the distortion correction 67 is performed.

When such processing is performed as the development processing 46 in FIG. 6, the distortion correction parameter and the like calculated in the distortion correction parameter calculation processing 45 are used.

In a case where RAW image data to be subjected to the development processing 46 is stored in the image storage DB 42, optical center information and individual adjustment values are stored in the information storage DB 44 in association with device information regarding the imaging device 100 that has captured the RAW image data. In addition, the imaging information and/or the recognition information are stored in the information storage DB 44 in association with each frame of the RAW image data.

In the distortion correction parameter calculation processing 45, the distortion correction parameter is calculated using the lens data, the optical center information, the individual adjustment value, the imaging information, and the recognition information in the device information.

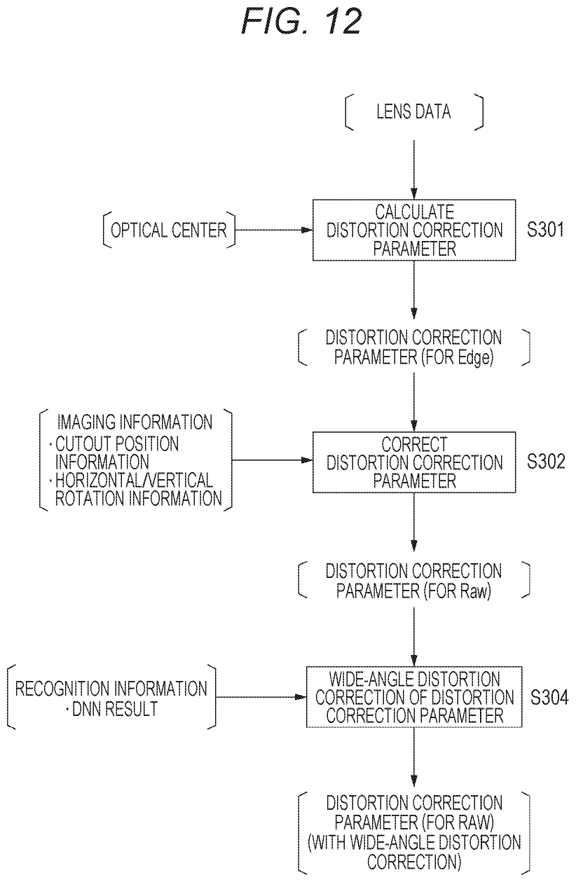

FIG. 12 illustrates an example of distortion correction parameter calculation processing.

In step S301, the CPU 71 of the information processing apparatus 103 calculates a distortion correction parameter on the basis of the lens data and the optical center information. The calculated distortion correction parameter is a distortion correction parameter for an edge, that is, used in the imaging device 100. For example, the information processing apparatus 103 can feed back the distortion correction parameter for the edge to the imaging device 100 as the distortion correction parameter used in the distortion correction 67 in the ISP 32.

In step S302, the CPU 71 creates the distortion correction parameter for the RAW image data using the imaging information (cutout position information, horizontal/vertical conversion information) in addition to the lens data and the optical center information. This is a parameter used for distortion correction on the RAW image data on the information processing apparatus 103 side.

In step S304, the CPU 71 creates the distortion correction parameter for the RAW image data to which the wide-angle distortion correction is added, using the recognition information, for example, the DNN result by the DSP 33.

For example, when distortion correction is performed in a case where the subject of the three-dimensional object is located at the corner of the image, the shape of the three-dimensional object is deformed into a state that is not the original shape. In particular, when distortion correction is accurately performed, wide-angle distortion can occur.

Therefore, in step S304, the processing is switched according to the recognition result of the subject.

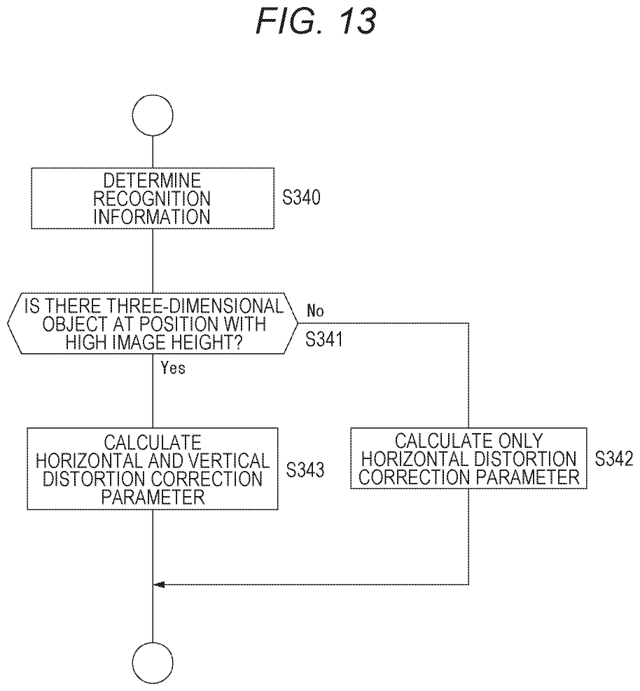

FIG. 13 illustrates a processing example of step S304.

In step S340, the CPU 71 of the information processing apparatus 103 performs determination processing on the recognition information. For example, the type (class) of the recognized object, the position of the object in the image, and the like are determined.

In step S341, the CPU 71 determines whether or not a subject as a three-dimensional object is present at a position with a high image height in the image.

In a case where the subject is present, the CPU 71 proceeds to step S343 and generates a distortion correction parameter for performing correction only in the horizontal direction so as not to generate wide-angle distortion.

In a case where a subject as a three-dimensional object is not present at a position with a high image height, distortion correction parameters for performing distortion correction on both of the horizontal and vertical directions are generated.

By switching the processing according to the recognition information in this manner, distortion correction that does not cause wide-angle distortion to occur can be performed.

As the distortion correction parameter calculation processing 45 in FIG. 6, when the distortion correction parameter is generated by the processing as described above, the information processing apparatus 103 can perform development processing 46 using the distortion correction parameter. Therefore, also on the information processing apparatus 103 side, appropriate distortion correction can be performed on the RAW image data.

Furthermore, in the development processing 46, processing such as shading correction, color adjustment, or the like can be performed using the information of the individual adjustment value read from the information storage DB 44. That is, it is possible to perform development processing according to the individual of the imaging device 100 that is the imaging source of the RAW image data to be processed.

Note that, in the distortion correction parameter calculation processing 45, in addition to the calculation of the distortion correction parameter, for example, a parameter used in the development processing may be calculated using an individual adjustment value. For example, when the individual adjustment value read from the information storage DB 44 is the parameter itself used for the development processing, it is not necessary to additionally calculate the parameter, but the parameter used for the development processing may be calculated on the basis of the individual adjustment value.

By the development processing 46, image data after development, for example, JPEG image data, bitmap image data, and the like are obtained.

For such image data, in some cases, the information processing apparatus 103 performs the processing of the procedures ST16, ST17, and ST18 illustrated in FIG. 5 as necessary and according to the content of the service to be provided.

Furthermore, regarding the procedure ST18, the distortion correction parameter calculated in the distortion correction parameter calculation processing may be memorized in the information storage DB 44 and fed back to the sensor 101 at some point so as to be applicable to the distortion correction processing in the ISP 32.

### 5. Second Embodiment

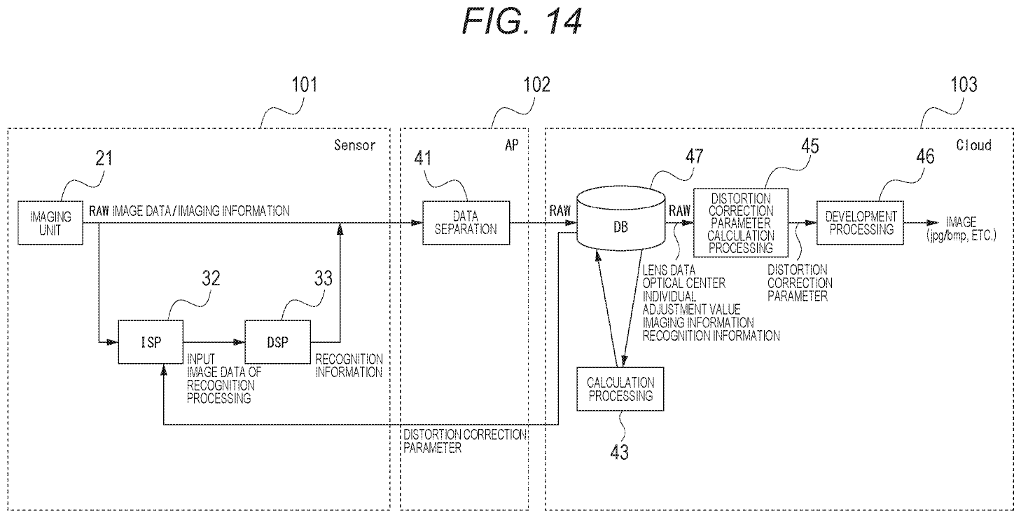

FIG. 14 illustrates a flow of processing of a second embodiment. FIG. 14 illustrates the flow of processing in a format similar to that of FIG. 6.

In FIG. 6, the image storage DB 42 and the information storage DB 44 are separated to store data, but FIG. 14 illustrates an example in which data is collectively stored in the DB 47 in the procedure ST6 or the procedure ST13 in the information processing apparatus 103.

That is, in the DB 47, the information of the optical center and the individual adjustment value are memorized in association with the device information of the imaging device 100.

In addition, RAW image data is memorized, and imaging information and recognition information are memorized for each frame of the RAW image data.

In the setting stage, as the calculation processing 43, the optical center is calculated from image data such as a grid image captured by the imaging device 100 as illustrated in FIG. 7. Then, the information of the optical center and the individual adjustment value are memorized in association with the device information of the imaging device 100.

In the operation stage, distortion correction parameter calculation processing 45 is performed using the lens data, the optical center, the imaging information, and the recognition information as illustrated in FIG. 12 for each frame of the RAW image data read from the DB 47. Then, the development processing 46 using the calculated distortion correction parameter and the individual adjustment value read from the DB 47 is performed.

### 6. Conclusion and Modification

According to the technology described in the embodiments, the following effects can be obtained.

The information processing apparatus 103 according to the embodiments performs first processing of acquiring, for example, information used for setting image processing parameters of the RAW image data, such as optical center information, individual adjustment values, and the like as individual information of the imaging device 100 that captures the RAW image data, and memorizing the individual information in association with the imaging device 100. That is, the processing is processing of the procedure ST6 in FIG. 5.

In a case where an information processing apparatus 103 that receives RAW image data from an external imaging device 100 is assumed, individual information of the imaging device 100 is managed in association with the imaging device 100.

Therefore, it is not necessary to memorize and manage the geometric deformation parameter and the like for each frame of the RAW image data, and enlargement of the data size can be suppressed.

In the embodiments, an example has been described in which the individual information is information of the optical center of the imaging device 100.

With this information, the lens distortion correction parameter according to the individual of the imaging device 100 can be calculated. The amount of information to be memorized for use in the development processing can be reduced by managing the optical center information in association with each individual of the imaging device 100 instead of each frame of the RAW image data. That is, it is not necessary to memorize the geometric deformation parameter for each frame.

In the embodiments, an example has been described in which information of the optical center of the imaging device 100 is calculated and acquired using image data received from the imaging device 100 (see FIG. 7).

It is possible to calculate and acquire information of the optical center of the imaging device 100 by using image data of an image, for example, a grid image, captured by the imaging device 100 in the setting stage.

In the embodiments, an example has been described in which the individual information is information of the individual adjustment value of the imaging device 100.

With this information, parameters for performing image processing according to the individual of the imaging device 100 on the information processing apparatus 103 side can be set.

For example, it is possible to calculate parameters related to hue correction, shading correction, and the like as image processing according to an individual of the imaging device 100. Therefore, image processing according to the imaging device 100 can be performed on the cloud side. It is also possible to feed back the parameters to the edge side.

As the individual adjustment value, the parameter of the hue adjustment and the parameter of the shading correction are exemplified, but information other than these is also conceivable. For example, parameters such as a white balance gain and a gamma curve are also conceivable.

In the embodiments, an example has been described in which second processing of storing the imaging information for each frame of the RAW image data is performed. That is, it is processing of storing the imaging information in the procedure ST13 of FIG. 5.

With this processing, information regarding processing at the time of imaging for each frame can be managed and used for subsequent processing. For example, information of processing at the time of imaging can be used for various types of image processing such as calculation of a distortion correction parameter, color adjustment processing, shading correction processing, luminance adjustment processing, and the like.

In the embodiments, an example has been described in which the imaging information is the cutout position information of the RAW image data.

By managing the cutout position information for each frame with respect to the RAW image data from the imaging device 100 side, it is possible to calculate an appropriate correction parameter for each frame.

For example, in a case where the optical center and the image center are deviated due to circumstances of an inexpensive imaging device 100 or the like, it is possible to calculate the distortion correction parameter with high accuracy by performing calculation in consideration of the cutout position of the captured image data. Furthermore, even in a case where the imaging device 100 adjusts the cutout position for each frame by a blur correction function or the like, the optical axis center and the image center are deviated from each other for each frame. Therefore, by managing the cutout position information of each frame, it is possible to calculate a highly accurate distortion correction parameter.

In the embodiments, an example has been described in which the imaging information is the horizontal/vertical rotation information of the RAW image data.

The information of the horizontal-vertical rotation processing for the RAW image data captured on the imaging device 100 side is managed for each frame, whereby an appropriate correction parameter reflecting the horizontal-vertical rotation processing can be calculated for each frame.

In the embodiment, an example has been described in which third processing that stores the recognition information of the image for each frame of the RAW image data is performed. That is, it is processing of storing the recognition information in the procedure ST13 of FIG. 5.

With this processing, the recognition information of the captured image for each frame, for example, information regarding the type of subject, the scene type, the composition, and the like can be managed, and can be used for subsequent processing. For example, the recognition information can be used for various types of image processing such as calculation of a distortion correction parameter, color adjustment processing, shading correction processing, luminance adjustment processing, and the like.

In the embodiments, an example has been described in which the recognition information is information indicating a result of object recognition for a subject of an image.

By managing the object recognition result of the subject of the RAW image captured on the imaging device 100 side, for example, the result of the DNN processing, for each frame, an appropriate distortion correction parameter according to the recognition result can be calculated for each frame. For example, as described with reference to FIGS. 12 and 13, by switching the method of calculating the distortion correction parameter according to the three-dimensional object, the distortion correction parameter that does not cause wide-angle distortion to occur can be calculated.

In the embodiments, an example has been described in which fourth processing of calculating the distortion correction parameter using the individual information is performed. That is, the processing is processing of the procedure ST14 in FIG. 5.

As described with reference to FIG. 12, the distortion correction parameter (for edge, for RAW) is calculated using the information of the optical center as the individual information. As a result, it is possible to calculate the distortion correction parameter corresponding to the imaging device 100 that is the imaging source of the RAW image.

In the embodiments, an example has been described in which the distortion correction parameter is calculated using the individual information and the imaging information.

In step S302 of FIG. 12, the distortion correction parameter (for RAW) reflecting the imaging information is calculated. As a result, distortion correction reflecting imaging information for each frame can be performed on the cloud side.

In the embodiments, an example has been described in which the distortion correction parameter is calculated using the individual information and the recognition information.

In step S304 of FIG. 12, the distortion correction parameter (for RAW) reflecting the recognition information is calculated. With this processing, distortion correction reflecting recognition information for each frame can be performed on the cloud side. For example, it is possible to calculate a distortion correction parameter such that wide-angle distortion does not occur due to the presence of a three-dimensional object at a position with a high image height.

In the embodiment, an example has been described in which fifth processing of developing the RAW image data using the distortion correction parameter calculated in the fourth processing is performed. That is, the processing is processing of the procedure ST15 in FIG. 5.

That is, the information processing apparatus 103 on the cloud side performs the development processing 46 in FIGS. 6 and 14. As a result, image data visible on the cloud side, for example, JPEG image data, bitmap image data, and the like can be generated for the RAW image captured on the edge side, and can be provided to the user.

Note that the cloud-side processing described with reference to FIGS. 6 and 14 may be performed by one information processing apparatus 103 or may be distributed and executed by a plurality of information processing apparatuses 103.

The first processing (procedure ST6), the second processing (storage of imaging information in procedure ST13), the third processing (storage of recognition information in procedure ST13), the fourth processing (procedure ST14), and the fifth processing (procedure ST15) may be individually or partially executed by the separate information processing apparatus 103.

The second processing to the fifth processing in the operation stage may be performed continuously in time series or are not necessarily performed continuously.

The technology of the present disclosure is not limited to cloud computing, and can be widely applied to a case where a RAW image is handled by an information processing apparatus separate from an imaging apparatus (camera).

For example, in an information processing apparatus, an image processing apparatus, an image editing apparatus, or the like connected to a digital camera so as to enable wired or wireless data communication, processing similar to that of the cloud-side information processing apparatus 103 described in the above-described embodiments can be performed. Also in this case, distortion correction and image processing can be appropriately performed on the RAW image data, and it is not necessary to memorize the geometric deformation parameter or the like for each frame, and the effect of reducing the data amount can be obtained.

The program according to the embodiments is a program for causing, for example, a CPU, a DSP, a GPU, a GPGPU, an AI processor, or the like, or a device including the CPU, the DSP, the GPU, the GPGPU, the AI processor, or the like, to execute processing for implementing the information processing method described above with reference to FIGS. 5, 6, and 14.

That is, the program of the embodiments is a program for causing the information processing apparatus 103 to execute processing of acquiring individual information used for setting an image processing parameter of RAW image data and memorizing the individual information in association with the imaging device 100, for the imaging device 100 that captures the RAW image data.

With such a program, the information processing apparatus 103 referred to in the present disclosure can be implemented by various types of computer apparatuses.

These programs can be recorded in advance in an HDD as a recording medium built in equipment such as a computer apparatus, a ROM in a microcomputer having a CPU, or the like.

Alternatively, the program can be temporarily or permanently housed (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, a memory card, or the like. Such a removable recording medium can be provided as what is called package software.

Furthermore, such a program can be installed from the removable recording medium into a personal computer or the like, or can be downloaded from a download site via a network such as a local area network (LAN) or the Internet.

Furthermore, such a program is suitable for providing the information processing apparatus of the present disclosure in a wide range. For example, by downloading the program to a mobile terminal device such as a smartphone, a tablet, or the like, a mobile phone, a personal computer, game equipment, video equipment, a personal digital assistant (PDA), or the like, such equipment can be caused to function as the information processing apparatus of the present disclosure.

Note that the effects described in the present specification are merely examples and are not limited, and there may be other effects.

Note that the present technology can also employ the following configurations.

(1)

An information processing method, in which
an information processing apparatus performs
first processing of acquiring individual information used for setting an image processing parameter of RAW image data for an imaging device that captures the RAW image data and memorizing the individual information in association with the imaging device.
   (2)

The information processing method according to (1) described above, in which
the individual information includes information of an optical center of the imaging device.
   (3)

The information processing method according to (2) described above, in which
the information of the optical center of the imaging device is calculated and acquired using image data received from the imaging device.
   (4)

The information processing method according to any one of (1) to (3) described above, in which
the individual information is information of an adjustment value for image processing of the imaging device.
   (5)

The information processing method according to any one of (1) to (4) described above, in which
second processing of storing imaging information for each frame of the RAW image data is further performed.
   (6)

The information processing method according to (5) described above, in which
the imaging information includes cutout position information of the RAW image data.
   (7)

The information processing method according to (5) or (6) described above, in which
the imaging information includes horizontal/vertical rotation information of the RAW image data.
   (8)

The information processing method according to any one of (1) to (7) described above, in which
third processing of storing recognition information of the image for each frame of the RAW image data is further performed.
   (9)

The information processing method according to (8) described above, in which
the recognition information includes information indicating a result of object recognition for a subject of the image.
   (10)

The information processing method according to any one of (1) to (9) described above, in which
fourth processing of calculating a distortion correction parameter using the individual information is further performed.
   (11)

The information processing method according to any one of (5) to (7) described above, in which
fourth processing of calculating a distortion correction parameter using the individual information and the imaging information is further performed.
   (12)

The information processing method according to (8) or (9) described above, in which
fourth processing of calculating a distortion correction parameter using the individual information and the recognition information is further performed.
   (13)

The information processing method according to any one of (10) to (12) described above, in which
fifth processing of developing the RAW image data using the distortion correction parameter calculated in the fourth processing is further performed.
   (14)

An information processing apparatus including:
a processing unit that acquires individual information to be used for setting an image processing parameter of RAW image data for an imaging device that captures the RAW image data and memorizes the individual information in association with the imaging device.
   (15)

A program configured to cause an information processing apparatus to execute processing of acquiring individual information to be used for setting an image processing parameter of RAW image data for an imaging device that captures the RAW image data and memorizing the individual information in association with the imaging device.

### REFERENCE SIGNS LIST

20 Imaging block
21 Imaging unit
22 Imaging processing unit
23 Output control unit
25 Imaging control unit
30 Signal processing block
31 CPU
32 ISP
33 DSP
37 Memory
41 Data separation processing
42 Image storage DB
43 Calculation processing
44 Information storage DB
45 Distortion correction parameter calculation processing
46 Development processing
47 DB
71 CPU
100 Imaging device
101 Sensor
102 Application processor
103 Information processing apparatus
104 Network
105 Optical system

1. An information processing method, wherein
an information processing apparatus performs
first processing of acquiring individual information used for setting an image processing parameter of RAW image data for an imaging device that captures the RAW image data and memorizing the individual information in association with the imaging device.

2. The information processing method according to claim 1, wherein
the individual information includes information of an optical center of the imaging device.

3. The information processing method according to claim 2, wherein
the information of the optical center of the imaging device is calculated and acquired using image data received from the imaging device.

4. The information processing method according to claim 1, wherein
the individual information is information of an adjustment value for image processing of the imaging device.

5. The information processing method according to claim 1, wherein
second processing of storing imaging information for each frame of the RAW image data is further performed.

6. The information processing method according to claim 5, wherein
the imaging information includes cutout position information of the RAW image data.

7. The information processing method according to claim 5, wherein
the imaging information includes horizontal/vertical rotation information of the RAW image data.

8. The information processing method according to claim 1, wherein
third processing of storing recognition information for each frame of the RAW image data is further performed.

9. The information processing method according to claim 8, wherein
the recognition information includes information indicating a result of object recognition for a subject of an image.

10. The information processing method according to claim 1, wherein
fourth processing of calculating a distortion correction parameter using the individual information is further performed.

11. The information processing method according to claim 5, wherein
fourth processing of calculating a distortion correction parameter using the individual information and the imaging information is further performed.

12. The information processing method according to claim 8, wherein
fourth processing of calculating a distortion correction parameter using the individual information and the recognition information is further performed.

13. The information processing method according to claim 10, wherein
fifth processing of developing the RAW image data using the distortion correction parameter calculated in the fourth processing is further performed.

14. An information processing apparatus comprising:
a processing unit that acquires individual information to be used for setting an image processing parameter of RAW image data for an imaging device that captures the RAW image data and memorizes the individual information in association with the imaging device.

15. A program configured to cause an information processing apparatus to execute
processing of acquiring individual information to be used for setting an image processing parameter of RAW image data for an imaging device that captures the RAW image data and memorizing the individual information in association with the imaging device.
